(19) United States
(12) Patent Application Publication
(10) Pub. No.: US 2015/0042948 A1
(43) Pub. Date: Feb. 12, 2015

(54) EYEGLASSES

(71) Applicant: Wei-Ti Chao, Minsyong Township (TW)

(72) Inventor: Chi-On CHUNG, New Territories (HK)

(21) Appl. No.: 14/453,496

(22) Filed: Aug. 6, 2014

(30) Foreign Application Priority Data
Aug. 7, 2013 (CN) 201320482136.1

(51) Int. Cl. G02C 5/14

(52) U.S. Cl. CPC G02C 5/14
USPC 351/116

(57) ABSTRACT

A pair of eyeglasses includes a bottom lens frame, a top lens frame and two temples. The bottom lens frame has opposite bottom engaging portions, and a bottom bridge portion that is disposed between the bottom engaging portions. The top lens frame has a top bridge portion that is removably connected to the bottom bridge portion of the bottom lens frame, and two top engaging portions that are disposed respectively at opposite sides of the top bridge portion and that are proximate respectively to the bottom engaging portions. Each of the temples includes an end piece that engages removably a respective one of the top engaging portions of the top lens frame and a respective one of the bottom engaging portions of the bottom lens frame.

### CROSS-REFERENCE TO RELATED APPLICATION

This application claims priority of Chinese Patent Application No. 201320482136.1, filed on Aug. 7, 2013.

### BACKGROUND OF THE INVENTION

1. Field of the Invention

The invention relates to a pair of eyeglasses, more particularly to a pair of eyeglasses with replaceable parts.

2. Description of the Related Art

Currently, a pair of conventional eyeglasses with replaceable parts generally includes replaceable temples coupled detachably to a frame via mechanisms such as magnets, removable screws, etc., so that the replacement operation is inconvenient and time-consuming. Moreover, frames of the abovementioned conventional eyeglasses are generally non-replaceable. Hence, there is still room for improvement.

### SUMMARY OF THE INVENTION

Therefore, the object of the present invention is to provide a pair of eyeglasses that can eliminate the aforesaid drawbacks of the prior art.

According to the present invention, there is provided a pair of eyeglasses including a bottom lens frame, a top lens frame and two temples. The bottom lens frame has opposite bottom engaging portions, and a bottom bridge portion that is disposed between the bottom engaging portions. The top lens frame has a top bridge portion and two top engaging portions. The top bridge portion is removably connected to the bottom bridge portion of the bottom lens frame. The top engaging portions are disposed respectively at opposite sides of the top bridge portion and are proximate respectively to the bottom engaging portions. Each of the temples includes an end piece that engages removably a respective one of the top engaging portions of the top lens frame and a respective one of the bottom engaging portions of the bottom lens frame.

### BRIEF DESCRIPTION OF THE DRAWINGS

Other features and advantages of the present invention will become apparent in the following detailed description of the preferred embodiment with reference to the accompanying drawings, of which:

FIG. 1 is an assembled perspective view of a preferred embodiment of a pair of eyeglasses according to the present invention;

FIG. 2 is an exploded perspective view of the preferred embodiment;

FIG. 3 is a partially assembled perspective view of a bottom lens frame and a top lens frame of the preferred embodiment;

FIG. 4 is a fragmentary exploded perspective view of the top and bottom lens frames and an end piece of a temple of the preferred embodiment;

FIG. 5 is a fragmentary sectional view of the top and bottom lens frames, the end piece of the temple of the preferred embodiment;

FIG. 6 is an assembled fragmentary top sectional view of the top and bottom lens frames, the end piece of the temple of the preferred embodiment, illustrating a movable segment of the top lens frame in a default state; and

FIG. 7 is a view similar to FIG. 6, but illustrating the movable segment in a depressed state.

### DETAILED DESCRIPTION OF THE PREFERRED EMBODIMENT

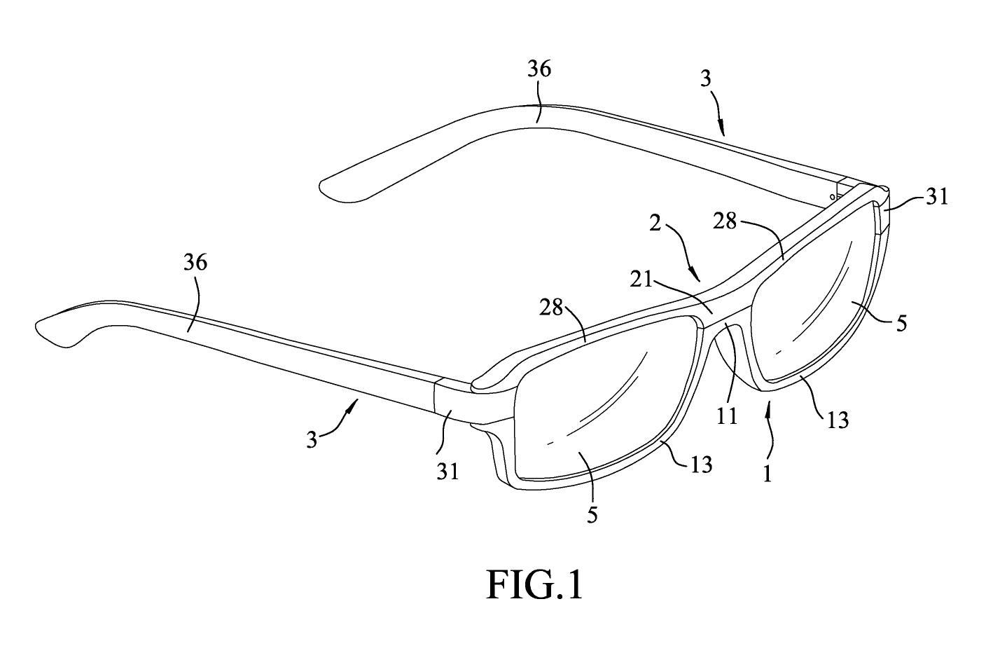

Referring to FIG. 1, a preferred embodiment of a pair of eyeglasses according to the present invention includes a bottom lens frame 1, a top lens frame 2, two temples 3 and two lenses 5.

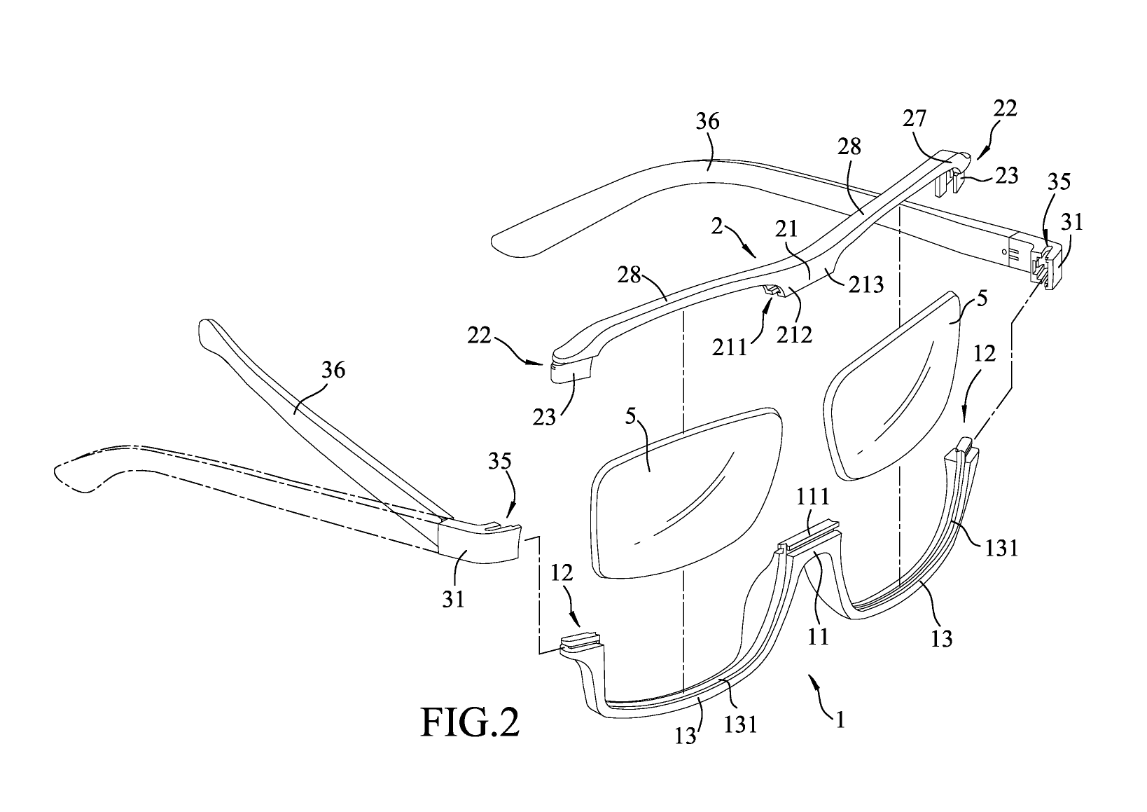

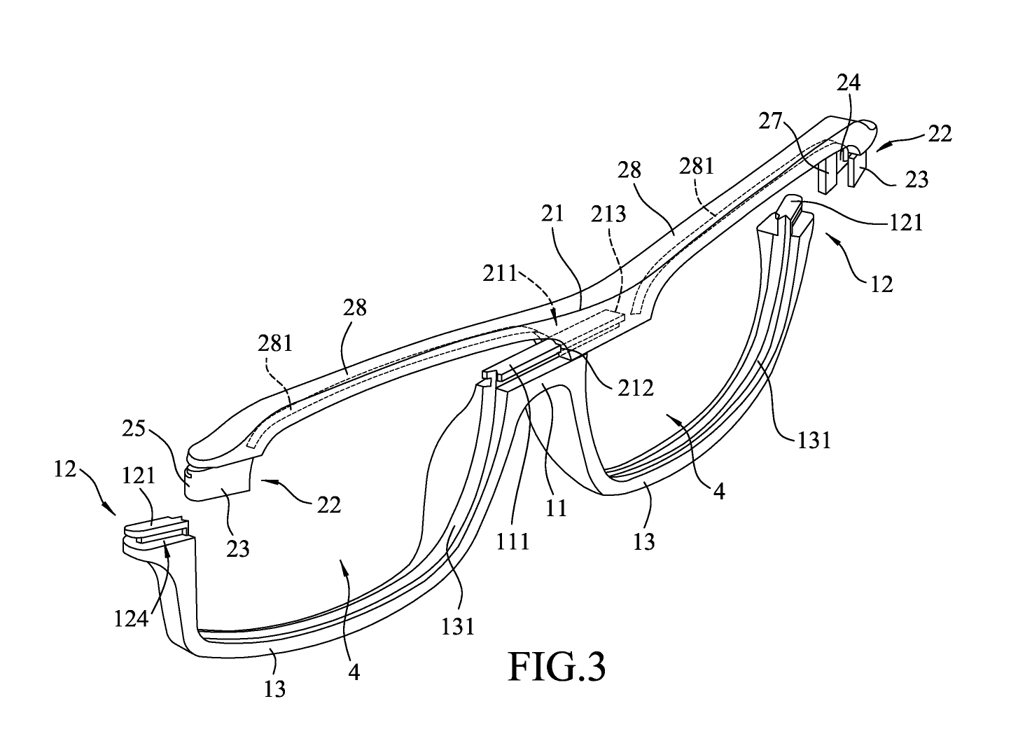

Referring to FIGS. 2 to 4, the bottom lens frame 1 has opposite bottom engaging portions 12, a bottom bridge portion 11 disposed between the bottom engaging portions 12, and two substantially U-shaped bottom rim portions 13. Each bottom rim portion 13 is connected between the bottom bridge portion 11 and a respective one of the bottom engaging portions 12. In this embodiment, the bottom bridge portion 11 is provided with an engaging block 111.

The top lens frame 2 has a top bridge portion 21 removably connected to the bottom bridge portion 11 of the bottom lens frame 1, two top engaging portions 22 disposed respectively at opposite sides of the top bridge portion 21 and being proximate respectively to the bottom engaging portions 12 of the bottom lens frame 1, and two substantially inverted U-shaped top rim portions 28. Each top rim portion 28 is connected between the top bridge portion 21 and a respective one of the top engaging portions 22, and cooperates with a respective one of the bottom rim portions 13 of the bottom lens frame 1 to define a lens accommodating space 4. Each of the lenses 5 is accommodated removably in the lens accommodating space 4 defined by a respective pair of the bottom and top rim portions 13, 28. Each of the bottom rim portions 13 is formed with a bottom insertion slot 131 that is in spatial communication with the respective lens accommodating space 4. Each of the top rim portions 28 is formed with a top insertion slot 281 that is in spatial communication with the respective lens accommodating space 4. The bottom insertion slot 131 of each of the bottom rim portions 13 cooperates with the top insertion slot 281 of the respective one of the top rim portions 28 to allow insertion of the respective one of the lenses 5 into the respective lens accommodating space 4.

In this embodiment, the top bridge portion 21 is provided with a slide groove 211 extending in a left-right direction for removable engagement with the engaging block 111 of the bottom bridge portion 11, such that the top bridge portion 21 is slidable relative to the bottom bridge portion 11 in the left-right direction to be removably coupled to the bottom bridge portion 11. The slide groove 211 has an open end 212 and a closed end 213 opposite to the open end 212 in the left-right direction.

It should be noted herein that, in other embodiments of this invention, the engaging block 111 may be provided on the top bridge portion 21 and the slide groove 211 may be formed in the bottom bridge portion 11. Moreover, locations of the open end 212 and the closed end 213 is interchangeable.

Each of the temples 3 includes an end piece 31 and a temple body 36 connected pivotally to the end piece 31. The end piece 31 engages removably a respective one of the top engaging portions 22 of the top lens frame 2 and a respective one of the bottom engaging portions 12 of the bottom lens frame 1.

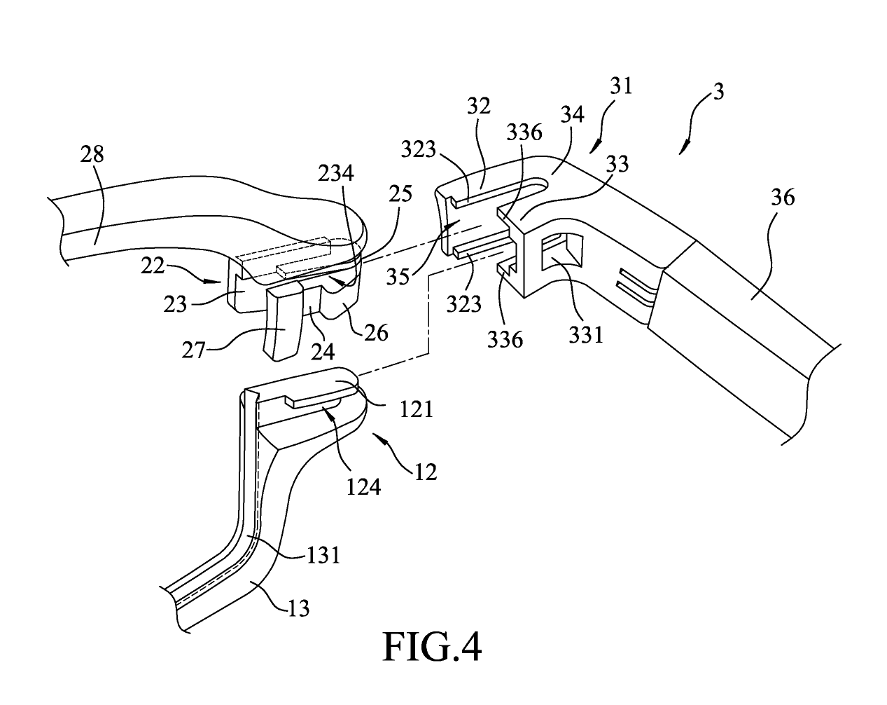

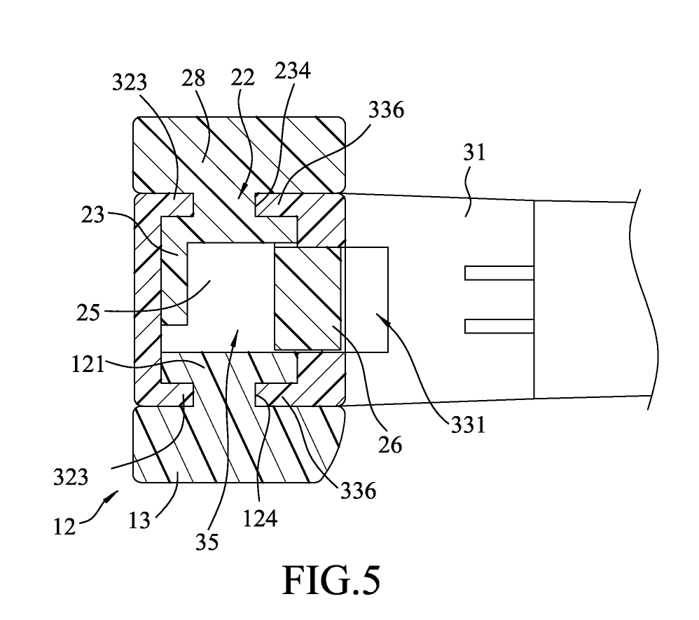

As shown in FIGS. 4, 5 and 6, each of the bottom engaging portions 12 has a bottom coupling block 121 that is formed with a bottom engaging space 124. In this embodiment, the bottom engaging space 124 is formed at a lower portion of the bottom coupling block 121. Each of the top engaging portions 22 is a substantially U-shaped snap, and has a connecting segment 23, a movable segment 24, a curved segment 25, a positioning segment 26 and a press segment 27. The connecting segment 23 is connected to the respective top rim portion 28, the movable segment 24 is spaced apart from and at the rear of the connecting segment 23, and the curved segment 25 is connected between the connecting segment 23 and the movable segment 24. The positioning segment 26 interconnects the movable segment 24 and the curved segment 25, and the press segment 27 is connected to an end of the movable segment 24 that is opposite to the positioning segment 26. In this embodiment, the curved segment 25 is connected between lateral outer ends of the connecting segment 23 and the positioning segment 26.

The connecting segment 23 of each of the top engaging portions 22 is formed with a top engaging space 234 at a position distal from the respective one of the bottom engaging portions 12 (i.e., the top engaging space 234 is formed at an upper portion of the connecting segment 23 of each of the top engaging portions 22). When any of the press segments 27 is pressed, the corresponding movable segment 24 will move toward the respective connecting segment 23.

The end piece 31 of each of the temples 3 has a first abutment portion 32, a second abutment portion 33 spaced apart from and at the rear of the first abutment portion 32, and a curved third abutment portion 34 interconnecting lateral outer ends of the first and second abutment portions 32, 33 and cooperating with the first and second abutment portions 32, 33 to define a U-shaped groove 35 for engagement with the respective one of the top engaging portions 22 and the respective one of the bottom engaging portions 12. The second abutment portion 33 is formed with a coupling groove 331 that is in spatial communication with the U-shaped groove 35.

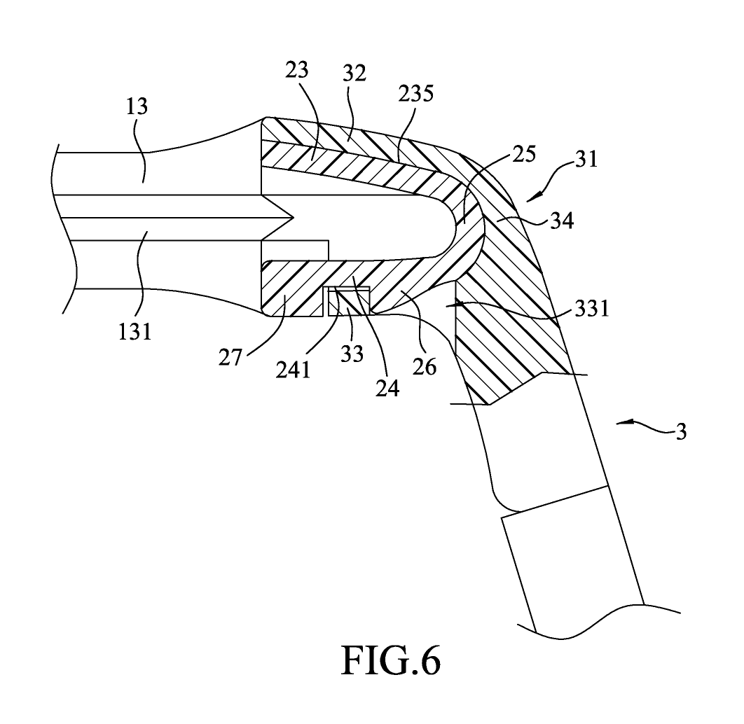

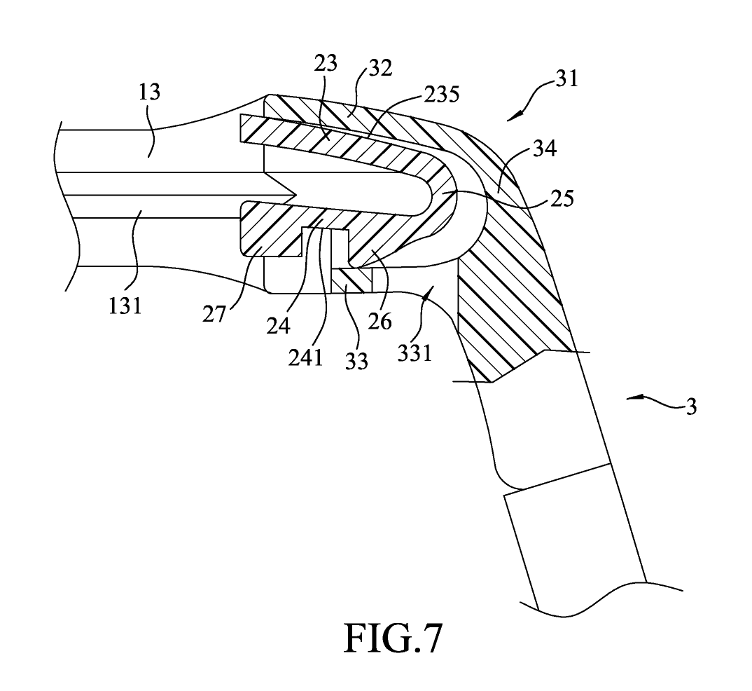

For each of the top engaging portions 22, the movable segment 24 is movable relative to the connecting segment 23 between a default state (see FIG. 6), where the movable segment 24 is distal from the connecting segment 23, and the curved segment 25 abuts against the end piece 31 of the respective one of the temples 3, and where the coupling groove 331 of the second abutment portion 33 is engaged with the positioning portion 26 to lock the top engaging portion 22, and a depressed state (see FIG. 7), where the movable segment 24 is proximate to the connecting segment 23, and the curved segment 25 is separated from the end piece 31 of the respective one of the temples 3, and where the positioning portion 26 is disengaged from the coupling groove 331 of the second abutment portion 33, thereby facilitating separation of the top engaging portion 22 from the end piece 31. When the movable segment 24 is in the depressed state, a distance between a rear outer side 241 of the movable segment 24 and a front outer side 235 of the connecting segment 23 is smaller than a width of the U-shaped groove 35 in a front-rear direction. When the movable segment 24 is in the default state, the distance between the rear outer side 241 of the movable segment 24 and the front outer side 235 of the connecting segment 23 is equal to the width of the U-shaped groove 35 in the front-rear direction.

The first abutment portion 32 of each of the temples 3 includes two first protruding blocks 323 that protrude respectively from top and bottom edges thereof toward the second abutment portion 33 of the corresponding temple 3. The second abutment portion 33 of each of the temples 3 includes two second protruding blocks 336 that protrude respectively from top and bottom edges thereof toward the first abutment portion 32 of the corresponding temple 3. The top one of the first protruding blocks 323 and the top one of the second protruding blocks 336 are inserted into and engage removably the top engaging space 234, and the bottom one of the first protruding blocks 323 and the bottom one of the second protruding blocks 336 are inserted into and engage removably the bottom engaging space 124, such that the first abutment portion 32 and the second abutment portion 33 are vertically immovable relative to a respective one of the top engaging portions 22 when the first and second protruding blocks 323, 336 are inserted into the corresponding top and bottom engaging spaces 234, 124.

To assemble the eyeglasses of the present invention, the engaging block 111 of the bottom lens frame 1 first slides into the slide groove 211 of the top lens frame 2 in the left-right direction through the open end 212 of the slide groove 211, so that the bottom lens frame 1 and the top lens frame 2 are coupled together. The engaging block 111 is limited by the closed end 213 of the slide groove 211 and would not slide out of the slide groove 211 to otherwise result in separation of the top lens frame 2 from the bottom lens frame 1. Each of the lenses 5 is then accommodated in the respective lens accommodating space 4 defined by the respective pair of the bottom and top rim portions 13, 28 by inserting the same into the top insertion slot 281 and the bottom insertion slot 131. Subsequently, the end piece 31 of each of the temples 3 is registered with and moved toward the respective top engaging portion 22 and the respective bottom engaging portion 12 for engagement. The positioning segment 26 of each top engaging portion 22 is then pushed by the corresponding second abutment portion 33 to move together with the movable segment 24 and the press segment 27 of the corresponding top engaging portion 22 toward the connecting segment 23 until the movable segment 24 of the corresponding top engaging portion 22 is in the depressed state. Once the movable segment 24 passes over the second abutment portion 33, the movable segment 24 is automatically restored back to the default state with the positioning segment 26 engaging the coupling groove 331.

For each top engaging portion 22, if any of the lenses 5, the top lens frame 2 and the bottom lens frame 1 needs replacement or detachment for maintenance, the press segment 27 is pressed toward the connecting segment 23 to move the movable segment 24 toward the connecting segment 23 to the depressed state while the positioning segment 26 is disengaged from the coupling groove 331. Afterward, the end piece 31 of the corresponding one of the temples 3 can be separated from the top engaging portion 22 and the corresponding bottom engaging portion 12. The bottom lens frame 1 and the top lens frame 2 can then be slightly pulled away from each other for subsequent removal of the lenses 5. Next, the bottom lens frame 1 can be moved in the left-right direction to slide the engaging block 111 out of the slide groove 211 for detachment of the bottom lens frame 1 from the top lens frame 2.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A pair of eyeglasses comprising:
a bottom lens frame having
opposite bottom engaging portions, and
a bottom bridge portion that is disposed between said bottom engaging portions;
a top lens frame having
a top bridge portion that is removably connected to said bottom bridge portion of said bottom lens frame, and
two top engaging portions that are disposed respectively at opposite sides of said top bridge portion and that are proximate respectively to said bottom engaging portions; and
two temples, each including an end piece that engages removably a respective one of said top engaging portions of said top lens frame and a respective one of said bottom engaging portions of said bottom lens frame.

2. The eyeglasses as claimed in claim 1, wherein said top bridge portion is slidable relative to said bottom bridge portion in a left-right direction to be engaged removably with said bottom bridge portion.

3. The eyeglasses as claimed in claim 2, wherein one of said bottom bridge portion and said top bridge portion is provided with a slide groove, and the other one of said bottom bridge portion and said top bridge portion is provided with an engaging block that is removably engageable with said slide groove for connecting removably said top bridge portion to said bottom bridge portion.

4. The eyeglasses as claimed in claim 1, wherein:
said bottom lens frame further has two substantially U-shaped bottom rim portions, each of which is connected between said bottom bridge portion and a respective one of said bottom engaging portions; and
said top lens frame further has two substantially inverted U-shaped top rim portions, each of which is connected between said top bridge portion and a respective one of said top engaging portions.

5. The eyeglasses as claimed in claim 4, wherein each of said bottom rim portions cooperates with a respective one of said top rim portions to define a lens accommodating space, said eyeglasses further comprising two lenses, each of which is removably accommodated in said lens accommodating space defined by a respective pair of said bottom and top rim portions.

6. The eyeglasses as claimed in claim 5, wherein:
each of said bottom rim portions is formed with a bottom insertion slot that is in spatial communication with said lens accommodating space; and
each of said top rim portions is formed with a top insertion slot that is in spatial communication with said lens accommodating space;
said bottom insertion slot of each of said bottom rim portions cooperates with said top insertion slot of the respective one of said top rim portions to allow insertion of the respective one of said lenses.

7. The eyeglasses as claimed in claim 1, wherein:
said end piece of each of said temples is provided with a U-shaped groove for engagement with the respective one of said top engaging portions and the respective one of said bottom engaging portions;
each of said top engaging portions is a substantially U-shaped snap, and has a connecting segment, a movable segment that is spaced apart from said connecting segment, and a curved segment that is connected between said connecting segment and said movable segment, said movable segment being movable relative to said connecting segment between a default state, where said movable segment is distal from said connecting segment and said curved segment abuts against said end piece of the respective one of said temples, and a depressed state, where said movable segment is proximate to said movable segment and said curved segment is separated from said end piece of the respective one of said temples, thereby facilitating separation of said top engaging portion from said end piece.

8. The eyeglasses as claimed in claim 7, wherein:
each of said top engaging portions further has a positioning segment interconnecting said movable segment and said curved segment;
said end piece of each of said temples has a first abutment portion, a second abutment portion spaced apart from said first abutment portion, and a curved third abutment portion interconnecting said first and second abutment portions and cooperating with said first and second abutment portions to define said U-shaped groove; and
said second abutment portion is formed with an coupling groove that is in spatial communication with said U-shaped groove, and that is engaged with said positioning portion when said movable segment is in the default state when the corresponding one of said temples is engaged with the respective one of said top engaging portions.

9. The eyeglasses as claimed in claim 8, wherein:
said connecting segment of each of said top engaging portions is formed with a top engaging space at a position distal from the respective one of said bottom engaging portions;
each of said bottom engaging portions has a bottom coupling block that is formed with a bottom engaging space;
said first abutment portion of each of said temples includes two first protruding blocks that protrude respectively from top and bottom edges thereof toward said second abutment portion of said temple; and
said second abutment portion of each of said temples includes two second protruding blocks that protrude respectively from top and bottom edges thereof toward said first abutment portion of said temple;
the top one of said first protruding blocks and the top one of said second protruding blocks are inserted into and engage removably said top engaging space, and the bottom one of said first protruding blocks and the bottom one of said second protruding blocks are inserted into and engage said bottom engaging space, such that said first abutment portion and said second abutment portion are vertically immovable relative to the respective one of said top engaging portions.

10. The eyeglasses as claimed in claim 8, wherein each of said top engaging portions further has a press segment that is connected to an end of said movable segment that is opposite to said positioning segment, and that is pressable to disengage said positioning segment from said coupling groove.
